(19) United States
(12) Patent Application Publication
(10) Pub. No.: US 2026/0320015 A1
(43) Pub. Date: Oct. 15, 2026

(54) TREE STRUCTURE GENERATION METHOD, INFORMATION PROCESSING APPARATUS, INFORMATION PROCESSING SYSTEM, AND TREE STRUCTURE GENERATION PROGRAM

(71) Applicant: FUJIFILM Corporation, Tokyo (JP)

(72) Inventors: Sae NESHIBA, Kanagawa (JP); Yutaka OISHI, Kanagawa (JP); Atsushi ITO, Kanagawa (JP); Yuko MASUDA, Kanagawa (JP); Shinnosuke SONODA, Kanagawa (JP); Shohei YANO, Kanagawa (JP); Yuji AKADA, Kanagawa (JP)

(73) Assignee: FUJIFILM Corporation, Tokyo (JP)

(21) Appl. No.: 19/690,398

(22) Filed: May 28, 2026

Related U.S. Application Data
(63) Continuation of application No. PCT/JP2024/033956, filed on Sep. 24, 2024.

(30) Foreign Application Priority Data
Nov. 30, 2023 (JP) 2023-203359

(51) Int. Cl. G06F 16/22

(52) U.S. Cl. CPC G06F 16/2246; G06F 16/2255

(57) ABSTRACT

In a case of creating a Merkle tree, a management server calculates first hash values 50 corresponding to each of a plurality of pieces of data classified into a plurality of data groups for each predetermined reference condition and arranged such that data having a common reference condition are adjacent to each other, classifies a predetermined number of the first hash values 50 as a group into a first hash value group 52, calculates second hash values 54 corresponding to each of the first hash value groups 52 based on the first hash values 50 belonging to the plurality of first hash value groups 52, and calculates a top hash value 60 based on a plurality of the second hash values 54.

### CROSS-REFERENCE TO RELATED APPLICATIONS

This application is a continuation application of International Application No. PCT/JP2024/033956, filed Sep. 24, 2024, the disclosure of which is incorporated herein by reference in its entirety. Further, this application claims priority from Japanese Patent Application No. 2023-203359, filed Nov. 30, 2023, the disclosure of which is incorporated herein by reference in its entirety.

### BACKGROUND

### 1. Technical Field

The present disclosure relates to a tree structure generation method, an information processing apparatus, an information processing system, and a tree structure generation program.

### 2. Related Art

JP2020-507866A discloses a technology for sorting data of a leaf node, arranging the data in a sub-leaf node corresponding to each of the data by sequentially selecting a preset number of pieces of data from the sorted data, extracting the data of each sub-leaf node, sorting the data in accordance with an order of time stamps of the data, and calculating a hash value of the sorted data, that is, a hash value of the sub-leaf node, in order to shorten a time of a calculation process and improve calculation efficiency in verification of a blockchain node.

JP2023-72051A discloses a technology for calculating a hash of a second node that is a next level of a first node, a hash of a next level of the second node, and a Merkle root by calculating a hash of a next level using two different hashes present at each level in a Merkle branch in a Merkle tree for verifying a set of transactions in a block.

JP2022-527610A discloses a technology for calculating a Merkle root by a miner in a technology related to propagation of a block between miner nodes in a blockchain network.

### SUMMARY

In a blockchain technology, there is a Merkle tree as a method of summarizing and storing larger data. However, in order to verify consistency with the stored data from a reference to only data as one of leaf nodes of the Merkle tree, it is necessary to acquire and calculate hash values for a depth until a root node is reached.

The present disclosure has been made in consideration of the above-described circumstances, and an object of the present disclosure is to provide a tree structure generation method, an information processing apparatus, an information processing system, and a tree structure generation program capable of reducing the number of hash values of nodes to be acquired, as compared with a case of generating a Merkle tree without considering an arrangement of data, in a case of performing data verification using a Merkle tree in a blockchain technology.

In order to achieve the above object, according to a first aspect of the present disclosure, there is provided a tree structure generation method executed by a computer, the method comprising: calculating first hash values corresponding to each of a plurality of pieces of data classified into a plurality of data groups for each reference condition and arranged such that data having a common reference condition are adjacent to each other; classifying a predetermined number of the first hash values as a group into a first hash value group; calculating second hash values corresponding to each of the first hash value groups based on the first hash values belonging to a plurality of the first hash value groups; and calculating a top hash value based on a plurality of the second hash values.

According to a second aspect of the present disclosure, in the tree structure generation method according to the first aspect, in which the computer further performs classifying a plurality of pieces of data for each of the reference condition before calculating the top hash value, and changing an arrangement of the plurality of pieces of data for each of the reference condition.

According to a third aspect of the present disclosure, in the tree structure generation method according to the first aspect, in which the computer further performs classifying a predetermined number of the second hash values as a group into a second hash value group, calculating intermediate hash values corresponding to each of the second hash value groups based on the second hash values belonging to a plurality of the second hash value groups, and calculating a top hash value based on the intermediate hash values.

According to a fourth aspect of the present disclosure, in the tree structure generation method according to the first aspect, the reference condition may be at least one of a user ID, a registration date and time, and a format of the data.

According to a fifth aspect of the present disclosure, in the tree structure generation method according to the third aspect, in which the computer further performs classifying a plurality of the second hash values into a plurality of the second hash value groups such that the number of the second hash values included in the second hash value groups is two or one.

According to a sixth aspect of the present disclosure, in the tree structure generation method according to the first aspect, in which the computer further performs registering the top hash value, the first hash values, or the first hash values and the second hash values in a blockchain.

According to a seventh aspect of the present disclosure, there is provided an information processing apparatus comprising a processor, in which the processor is configured to: calculate first hash values corresponding to each of a plurality of pieces of data classified into a plurality of data groups for each reference condition and arranged such that data having a common reference condition are adjacent to each other; classify a predetermined number of the first hash values as a group into a first hash value group; calculate second hash values corresponding to each of the first hash value groups based on the first hash values belonging to a plurality of the first hash value groups; and calculate a top hash value based on a plurality of the second hash values.

According to an eighth aspect of the present disclosure, there is provided an information processing system comprising: the information processing apparatus according to the seventh aspect; and a client computer that transmits the plurality of pieces of data to the information processing apparatus.

According to a ninth aspect of the present disclosure, there is provided a tree structure generation program for causing a computer to execute a process comprising: calculating first hash values corresponding to each of a plurality of pieces of data classified into a plurality of data groups for each reference condition and arranged such that data having a common reference condition are adjacent to each other; classifying a predetermined number of the first hash values as a group into a first hash value group; calculating second hash values corresponding to each of the first hash value groups based on the first hash values belonging to a plurality of the first hash value groups; and calculating a top hash value based on a plurality of the second hash values.

According to the present disclosure, it is possible to provide a tree structure generation method, an information processing apparatus, an information processing system, and a tree structure generation program capable of reducing the number of hash values of nodes to be acquired, as compared with a case of generating a Merkle tree without considering the arrangement of data in a case of performing data verification using a Merkle tree in a blockchain technology.

### BRIEF DESCRIPTION OF THE DRAWINGS

Exemplary embodiments according to the technique of the present disclosure will be described in detail based on the following figures, wherein:

FIG. 1 is a block diagram illustrating an example of an overall configuration in an information processing system according to the present embodiment.

FIG. 2 is a block diagram illustrating a main configuration of an electric system of a management server and a client computer in the information processing system according to the present embodiment.

FIG. 3 is a diagram illustrating an example of a Merkle tree.

FIG. 4 is a functional block diagram illustrating a functional configuration of the management server in the information processing system according to the present embodiment.

FIG. 5 is a diagram illustrating an example of a flow of a process of creating a Merkle tree in the management server in the information processing system according to the present embodiment.

FIG. 6 is a flowchart illustrating an example of a flow of a process of changing the arrangement of the data for each reference condition in the information processing system according to the present embodiment.

FIG. 7 is a flowchart illustrating an example of a flow of a process of creating a Merkle tree and calculating the top hash value in the management server in the information processing system according to the present embodiment.

### DETAILED DESCRIPTION

Hereinafter, embodiments of the present invention will be described in detail with reference to the accompanying drawings. It should be noted that the present embodiment does not limit the present invention.

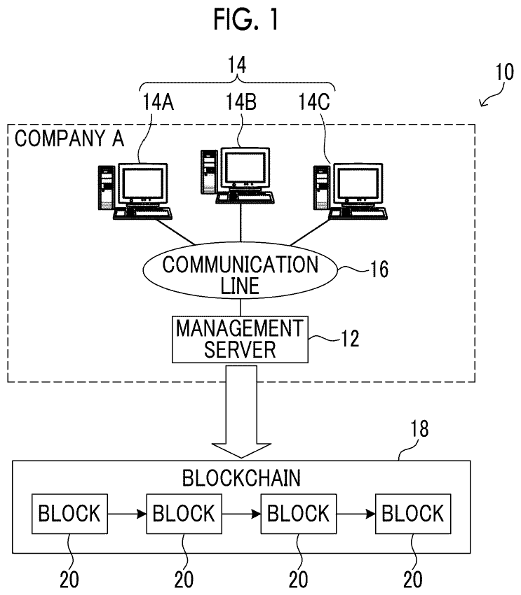

In the present embodiment, an information processing system in which a management server as an example of an information processing apparatus and a client computer are connected to each other via a communication line such as various networks will be described as an example. FIG. 1 is a block diagram illustrating an example of an overall configuration of an information processing system 10 according to the present embodiment.

As illustrated in FIG. 1, the information processing system 10 according to the present embodiment includes the management server 12 and a plurality of client computers 14 (14A, 14B, and 14C). The management server 12 and the client computer 14 are connected to each other via a communication line 16 such as a local area network (LAN), a wide area network (WAN), the Internet, and an intranet. The management server 12 and the client computer 14 can transmit and receive various types of data to and from each other via the communication line 16. It should be noted that, in FIG. 1, a case where three client computers 14 are provided is illustrated, but one or two client computers 14 may be provided, or four or more client computers 14 may be provided. In addition, a case where one management server 12 is provided is illustrated, but a plurality of management servers 12 may be provided.

In the present embodiment, the management server 12 writes data to the blockchain 18 in response to a registration request to the management server 12 from the client computer 14.

The blockchain 18 is configured by connecting the blocks 20 sequentially. The block 20 is a transaction (transaction data) of a predetermined data capacity, and is obtained by adding meta-information such as a time stamp (date) to the transaction data collected in a certain amount.

Meta-information such as a hash value and a nonce is added to each block 20 in addition to the time stamp. In each block 20, a previous block and a subsequent block are connected in a certain rule like a chain based on the information. The transaction is accumulated in real time and is bundled as the block 20 periodically. The block 20 including the transactions is held in each node constituting the blockchain 18, and is rectified because other nodes hold correct information even in a case where any node is tampered with. The hash value is derived by using a special encryption technology called a hash function. The nonce derives a random value such that the upper digits of the hash value are 0. Each node constituting the blockchain 18 may or may not include the management server 12.

It is assumed that the blockchain 18 and a user who uses the blockchain 18 are present. It is assumed that the user of the blockchain 18 writes to or refers to the blockchain irregularly.

In addition, for example, as shown in FIG. 1, the information processing system 10 according to the present embodiment will be described as being provided in Company A, and each client computer 14 is operated by a user belonging to Company A.

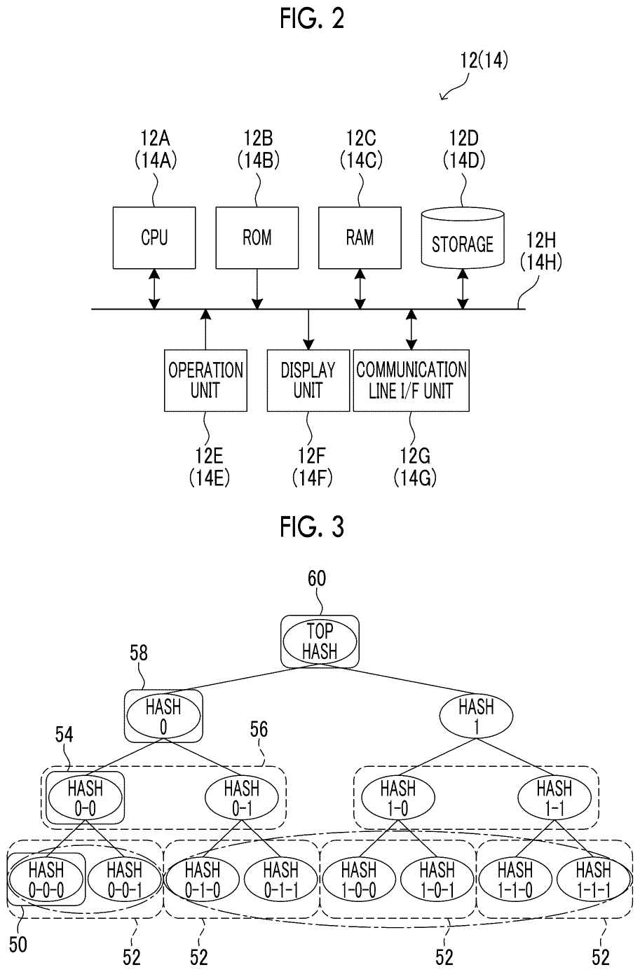

Subsequently, a main configuration of an electric system of the management server 12 and the client computer 14 of the information processing system 10 according to the present embodiment will be described. FIG. 2 is a block diagram illustrating a main configuration of the electric system of the management server 12 and the client computer 14 in the information processing system 10 according to the present embodiment. Since the management server 12 and the client computer 14 have a general computer configuration, the management server 12 will be described as a representative below.

As shown in FIG. 2, the management server 12 according to the present embodiment comprises a CPU 12A as an example of a processor, a ROM 12B, a RAM 12C, a storage 12D, an operation unit 12E, a display unit 12F, and a communication line interface (I/F) unit 12G. The CPU 12A controls the overall operation of the management server 12. The ROM 12B stores various control programs, various parameters, and the like in advance. The RAM 12C is used as a work area or the like in a case where various programs are executed by the CPU 12A. The storage 12D stores various types of data, an application program such as an update processing program of the blockchain 18, and the like. The operation unit 12E is used to input various types of information. The display unit 12F is used to display various types of information. The communication line I/F unit 12G is connected to the communication line 16 and transmits and receives various types of data to and from other apparatuses connected to the communication line 16. In addition, the communication line I/F unit 12G may be configured to be capable of directly communicating with each apparatus using various well-known wireless communications. Each unit of the management server 12 described above is electrically connected to each other by a system bus 12H. In the management server 12 according to the present embodiment, the storage 12D is applied as a storage unit, but as an example of the storage, a non-volatile storage unit such as a hard disk drive (HDD) or a flash memory is applied.

With the above configuration, the management server 12 according to the present embodiment executes each of access to the ROM 12B, the RAM 12C, and the storage 12D, acquisition of various types of data via the operation unit 12E, and display of various types of information on the display unit 12F, by the CPU 12A. In addition, the management server 12 executes control of transmission and reception of communication data via the communication line I/F unit 12G, by the CPU 12A.

Here, a data verification method using a Merkle tree as a tree structure in the technology of the blockchain 18 will be described. FIG. 3 is a diagram illustrating an example of the Merkle tree.

It is assumed that there is a user who is allowed to refer to only a part of the original data summarized in one Merkle tree. In addition, it is assumed that the target Merkle tree has the structure shown in FIG. 3.

A case is considered in which, in a case where the user himself/herself verifies consistency between data that the user can refer to and data that is summarized and stored in the Merkle tree, leaf nodes corresponding to the data that the user can refer to are distributed. For example, a case is considered in which the user can refer to “hash 0-0-0” and “hash 1-0-0” in FIG. 3.

In order to perform the target verification, it is necessary to acquire and calculate hashes for the depth of the Merkle tree. In the example of FIG. 3, it is necessary to acquire and calculate “hash 0-0-1”, “hash 0-1”, and “hash 1” or “hash 1-0-1”, “hash 1-1”, and “hash 0”.

Next, a case is considered in which data that the user can refer to is configured as a branch. For example, a case is considered in which “hash 0-0-0” and “hash 0-0-1” in FIG. 3 can be referred to.

In order to perform the target verification, it is possible to calculate the hashes for the depth to the target branch in the Merkle tree, in the example of FIG. 3, by acquiring only “hash 0-1” and “hash 1”.

From this, by creating a Merkle tree structure based on a condition to be referred to in advance, efficient data verification becomes possible.

For example, in a case where two pieces of data that can be referred to by a user A and six pieces of data that can be referred to by a user B are summarized as one Merkle tree shown in FIG. 3, the data that can be referred to by the user A is associated with “hash 0-0-0” and “hash 0-0-1” (one-dot chain line in FIG. 3), and the data that can be referred to by the user B is associated with “hash 0-1-0” to “hash 1-1-1” (two-dot chain line in FIG. 3).

Accordingly, in a case where the user A performs the data verification, only two pieces of “hash 0-1” and “hash 1” are acquired, and the user B can perform the verification by acquiring only “hash 0-0”.

Therefore, in a case of creating the Merkle tree, the management server 12 according to the present embodiment performs processing of calculating the first hash values 50 corresponding to each of a plurality of pieces of data that are classified into a plurality of data groups for each predetermined reference condition and that are arranged such that data having a common reference condition are adjacent to each other, classifying a predetermined number of the first hash values 50 into the first hash value groups 52 as a group, calculating the second hash values 54 corresponding to each of the first hash value groups 52 based on the first hash values 50 belonging to the plurality of first hash value groups 52, and calculating the top hash value 60 based on the plurality of second hash values 54.

The management server 12 may further perform processing of classifying the plurality of pieces of data for each reference condition and changing the arrangement of the plurality of pieces of data for each reference condition before performing the processing of calculating the top hash value.

In addition, the calculation of the top hash value 60 based on the plurality of second hash values 54 may be performed by classifying a predetermined number of the second hash values 54 into the second hash value groups 56 as a group, calculating the intermediate hash values 58 corresponding to each of the second hash value groups 56 based on the second hash values 54 belonging to the second hash value groups 56, and calculating the top hash value 60 based on the intermediate hash values 58. In addition, the plurality of second hash values may be classified into the plurality of second hash value groups such that the number of second hash values included in the second hash value group is two or one.

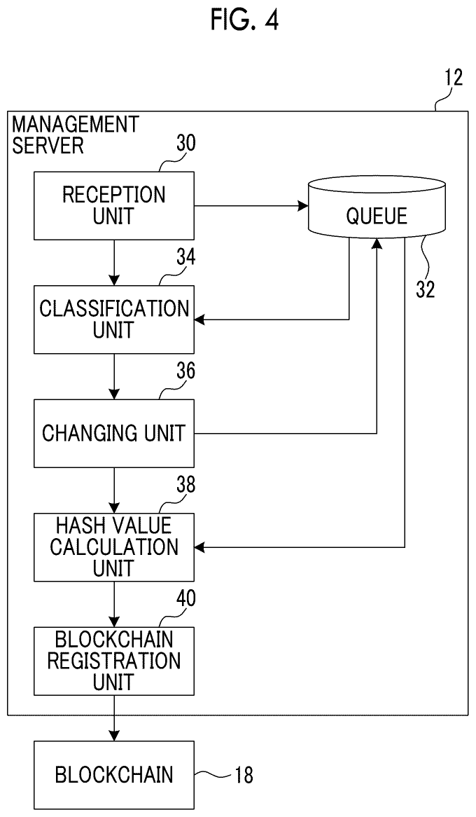

Specifically, the management server 12 has functions shown in FIG. 4 by expanding the program stored in the ROM 12B into the RAM 12C and executing the program via the CPU 12A. FIG. 4 is a functional block diagram illustrating a functional configuration of the management server 12 of the information processing system 10 according to the present embodiment.

That is, the management server 12 has functions shown in FIG. 4 by expanding the program stored in the ROM 12B into the RAM 12C and executing the program via the CPU 12A.

That is, the management server 12 has functions of a reception unit 30, a queue 32, a classification unit 34, a changing unit 36, a hash value calculation unit 38, and a blockchain registration unit 40.

The reception unit 30 receives a command to be registered in the blockchain 18, which is transmitted from the client computer 14, generates a hash value of the command, and stores the hash value in the queue 32. In addition, the reception unit 30 notifies the classification unit 34 that a predetermined number of hash values are accumulated in the queue 32 in a case where the hash values stored in the queue 32 are accumulated to the predetermined number.

The queue 32 is a storage area set in advance in the storage 12D, and the hash values generated by being transmitted from the client computer 14 are sequentially stored in the queue 32.

The classification unit 34 classifies data according to a reference condition of data of a calculation source of the hash value for the hash value stored in the queue 32. For example, as an example of the reference condition, at least one of a user ID, a registration date and time, or a format of data is applied, and the data is classified for each reference condition.

The changing unit 36 changes an arrangement of the hash values stored in the queue 32 based on a classification result of the classification unit 34. Specifically, the changing unit 36 changes the arrangement of the hash values such that data of a common reference condition is adjacent to each other.

The hash value calculation unit 38 generates a Merkle tree with a set of data of a common reference condition as a branch, and stores the hash value in the Merkle tree. In addition, the hash value of data having no common reference condition is stored in an empty leaf of the Merkle tree, and the Merkle tree is generated to obtain the hash value and a top hash value of each node.

The blockchain registration unit 40 registers the top hash value of the Merkle tree or the hash value of each node in the blockchain 18.

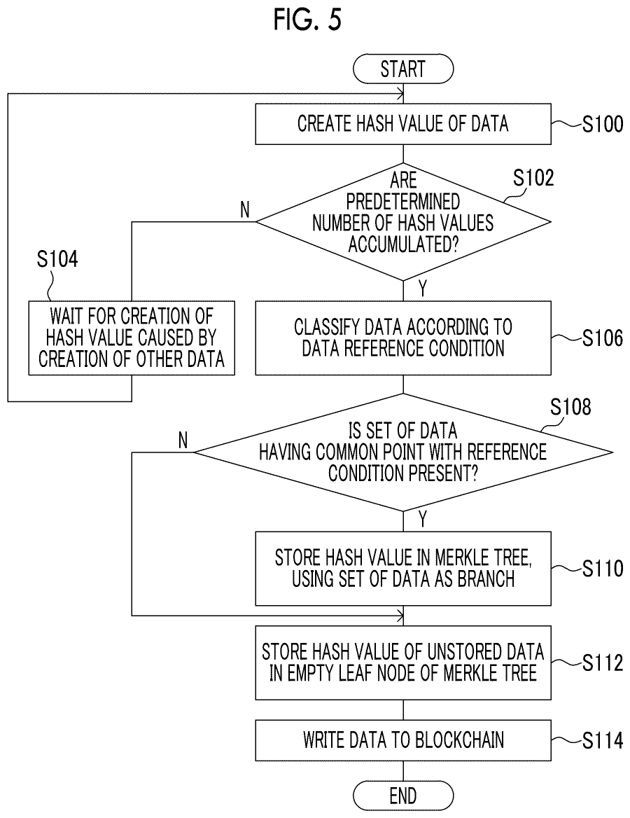

Subsequently, specific processing performed in a case where the Merkle tree is created in the management server 12 of the information processing system 10 according to the present embodiment configured as described above will be described. FIG. 5 is a diagram illustrating an example of a flow of processing performed in a case where the Merkle tree is created in the management server 12 of the information processing system 10 according to the present embodiment. The processing in FIG. 5 is started, for example, in a case where data to be registered in the blockchain 18 is received from the client computer 14.

In step S100, the CPU 12A creates the hash value of the data received from the client computer 14, stores the hash value in the queue 32, and proceeds to step S102. That is, the reception unit 30 receives a command to register the data in the blockchain 18, which is transmitted from the client computer 14, generates the hash value of the command, and stores the hash value in the queue 32.

In step S102, the CPU 12A determines whether or not a predetermined number of hash values are accumulated. In the determination, the reception unit 30 determines whether or not a predetermined number of hash values stored in the queue 32 are accumulated. In a case where the determination result is negative, the processing transitions to step S104, and in a case where the determination result is affirmative, the processing transitions to step S106.

In step S104, the CPU 12A waits for the creation of the hash value caused by the creation of other data, returns to step S100, and repeats the above-described processing. That is, the processing waits for a command from the client computer 14 and proceeds to step S100.

In step S106, the CPU 12A classifies the data according to the data reference condition, and proceeds to step S108. That is, the classification unit 34 classifies the data according to the data reference condition stored in the queue 32. For example, as an example of the reference condition, at least one of a user ID, a registration date and time, or a format of data is applied, and the data is classified for each reference condition.

In step S108, the CPU 12A determines whether or not a set of data having a common point with the reference condition is present. In a case where the determination result is affirmative, the processing transitions to step S110, and in a case where the determination result is negative, the processing transitions to step S112.

In step S110, the CPU 12A stores the hash value in the Merkle tree, using a set of data as a branch, and proceeds to step S112. That is, the changing unit 36 changes the arrangement of the plurality of data stored in the queue 32 based on the classification result of the classification unit 34 such that the data having a common reference condition are adjacent to each other. Then, the hash value calculation unit 38 generates the Merkle tree with the set of data having a common reference condition as a branch, and stores the hash value in the Merkle tree.

In step S112, the CPU 12A stores the hash value of the unstored data in an empty leaf node of the Merkle tree, and proceeds to step S114. That is, the hash value calculation unit 38 stores the hash value of the data having no common reference condition in an empty leaf node of the Merkle tree, generates the Merkle tree, and obtains the hash value and the top hash value of each node.

In step S114, the CPU 12A writes the data to the blockchain 18 to end the series of processing. That is, the blockchain registration unit 40 registers the top hash value of the Merkle tree or the hash value of each node in the blockchain 18.

By performing the processing in this way to regenerate the Merkle tree, in a case of performing the data verification using the Merkle tree, it is possible to reduce the number of hash values of the nodes to be acquired, as compared with a case of generating the Merkle tree without considering the arrangement of the data.

### Modification Example

Subsequently, a modification example will be described. In the above embodiment, an example has been described in which the processing of changing the arrangement of the data for each reference condition and the processing of creating the Merkle tree and calculating the top hash value are performed as a single processing, but in the modification example, an example will be described in which the processing of changing the arrangement of the data for each reference condition and the processing of creating the Merkle tree and calculating the top hash value are performed as separate processing. In the modification example, each function of the management server 12 functions as follows.

The reception unit 30 receives the command to register the data in the blockchain 18, which is transmitted from the client computer 14, as data and stores the data in the queue 32. In addition, the reception unit 30 notifies the classification unit 34 that a predetermined number of data are accumulated in the queue 32 in a case where the data stored in the queue 32 are accumulated to a predetermined number.

The queue 32 is a storage area set in advance in the storage 12D, and the commands transmitted from the client computer 14 are sequentially stored as data.

The classification unit 34 classifies the data according to the reference condition of the data stored in the queue 32. For example, as an example of the reference condition, at least one of the user ID, the registration date and time, or the format of the data is applied, and the data is classified for each reference condition.

The changing unit 36 changes the arrangement of the plurality of data stored in the queue 32 based on the classification result of the classification unit 34. Specifically, the changing unit 36 changes the arrangement of the plurality of data such that the data having a common reference condition are adjacent to each other.

The hash value calculation unit 38 generates a Merkle tree with a set of data of a common reference condition as a branch, and stores the hash value in the Merkle tree. In addition, the hash value of the data having no common reference condition is stored in an empty leaf node of the Merkle tree, and the Merkle tree is generated to obtain the hash value and the top hash value of each node.

The blockchain registration unit 40 registers the top hash value of the Merkle tree or the hash value of each node in the blockchain 18.

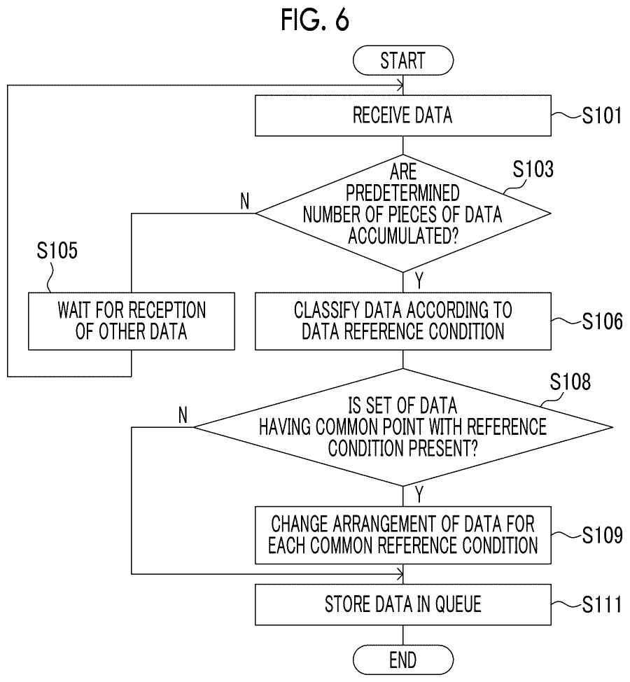

FIG. 6 is a flowchart illustratingg an example of a flow of processing of changing the arrangement of the data for each reference condition performed by the management server 12 of the information processing system 10 according to the present embodiment. The same processing as that in FIG. 5 is denoted by the same reference numerals.

In step S101, the CPU 12A receives the data from the client computer 14, stores the data in the queue 32, and proceeds to step S103. That is, the reception unit 30 receives a command to register the data in the blockchain 18, which is transmitted from the client computer 14.

In step S103, the CPU 12A determines whether or not a predetermined number of pieces of data are accumulated. In the determination, the reception unit 30 determines whether or not a predetermined number of pieces of data stored in the queue 32 are accumulated. In a case where the determination result is negative, the processing transitions to step S105, and in a case where the determination result is affirmative, the processing transitions to step S106.

In step S105, the CPU 12A waits for the reception of other data, returns to step S101, and repeats the above-described processing. That is, the processing waits for a command from the client computer 14 and proceeds to step S101.

In step S106, the CPU 12A classifies the data according to the data reference condition, and proceeds to step S108. That is, the classification unit 34 classifies the data according to the data reference condition stored in the queue 32. For example, as an example of the reference condition, at least one of a user ID, a registration date and time, or a format of data is applied, and the data is classified for each reference condition.

In step S108, the CPU 12A determines whether or not a set of data having a common point with the reference condition is present. In a case where the determination result is affirmative, the processing transitions to step S109, and in a case where the determination result is negative, the processing transitions to step S111.

In step S109, the CPU 12A changes the arrangement of the data for each common reference condition and proceeds to step S111. That is, the changing unit 36 changes the arrangement of the plurality of data stored in the queue 32 based on the classification result of the classification unit 34 such that the data having a common reference condition are adjacent to each other.

In step S111, the CPU 12A stores the data of which the arrangement is changed in the queue 32 and ends the series of processing. That is, the changing unit 36 stores the data in the queue 32 in the order in which the arrangement is changed.

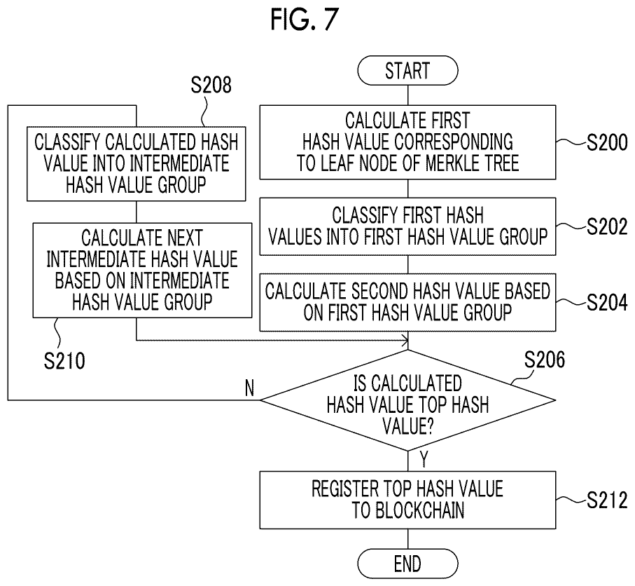

FIG. 7 is a flowchart illustrating an example of a flow of processing of creating a Merkle tree and calculating a top hash value, which is performed by the management server 12 of the information processing system 10 according to the present embodiment.

In step S200, the CPU 12A calculates the first hash value 50 corresponding to the leaf node of the Merkle tree and proceeds to step S202. That is, the hash value calculation unit 38 sequentially extracts the data stored in the queue 32 and calculates the first hash value corresponding to the leaf node of the Merkle tree.

In step S202, the CPU 12A classifies the first hash values 50 having a predetermined number into a first hash value group 52 as a group and proceeds to step S204. In the present embodiment, two first hash values 50 are classified into the first hash value group 52 as a group. That is, the hash value calculation unit 38 classifies the two first hash values into the first hash value group 52 as a group.

In step S204, the CPU 12A calculates the second hash value 54 based on the first hash value 50 of the first hash value group 52 and proceeds to step S206. That is, the hash value calculation unit 38 calculates the second hash value from the hash values of the first hash value group 52.

In step S206, the CPU 12A determines whether or not the calculated hash value is the top hash value 60. In a case where the determination result is negative, the processing transitions to step S208, and in a case where the determination result is affirmative, the processing transitions to step S212.

In step S208, the calculated hash value is classified into an intermediate hash value group as a group of a predetermined number of intermediate hash values 58 as the intermediate hash values 58 and proceeds to step S210. In the present embodiment, two intermediate hash values 58 are classified into the intermediate hash value group as a group. That is, the hash value calculation unit 38 classifies the two intermediate hash values 58 into the intermediate hash value group as a group.

In step S210, the CPU 12A calculates the next intermediate hash value based on the intermediate hash value group, returns to step S206, and repeats the above-described process. In a case where the calculated intermediate hash value is the top hash value, the process proceeds to step S212. That is, the hash value calculation unit 38 calculates the next intermediate hash value from the intermediate hash values of the intermediate hash value group. Specifically, the second hash value 54 of the Merkle tree shown in FIG. 3 is calculated, and steps S206 to S210 are repeated to sequentially calculate the intermediate hash values 58 upward in the Merkle tree.

In step S212, the CPU 12A writes the calculated top hash value to the blockchain 18 and ends the series of processes. That is, the blockchain registration unit 40 registers the calculated top hash value in the blockchain. Instead of the top hash value, the hash value of each node, such as the first hash value, the second hash value, and the intermediate hash value, may be registered in the blockchain 18. Alternatively, only the first hash value corresponding to the leaf node of the generated Merkle tree may be registered in the blockchain 18.

In the above-described embodiment, an example in which the management server 12 executes the processes of FIGS. 5 to 7 has been described, but the present disclosure is not limited thereto. For example, a form may be adopted in which the smart contract function on the blockchain 18 executes the processes of FIGS. 5 to 7.

In addition, in the above-described embodiment, the Merkle tree in which one node (branch) is generated from two leaf nodes has been described as an example, but a tree structure in which one node is generated from three leaf nodes may be applied, or a tree structure in which one node is generated from four or more leaf nodes may be applied.

In addition, various types of processing executed by the CPU by executing software (program) in the above-described embodiment may be executed by a computer equipped with various processors other than the CPU. In this case, the examples of the processors include a programmable logic device (PLD) such as a field-programmable gate array (FPGA) having a circuit configuration changeable after manufacturing, a dedicated electric circuit such as an application specific integrated circuit (ASIC) that is a processor having a circuit configuration dedicatedly designed to execute specific processing, and the like. The various types of processing may be executed by one of the various processors or may be executed by a combination of two or more processors of the same kind or different kinds (for example, a plurality of FPGAs and a combination of a CPU and an FPGA). Furthermore, the hardware structures of the various processors are more specifically electrical circuitry where circuit elements, such as semiconductor elements, are combined.

Further, in the above embodiment, an aspect in which various programs are stored (installed) in the ROM 12B in advance has been described. However, the present disclosure is not limited thereto. Various programs may be provided in a form of being recorded in a recording medium such as a compact disk read only memory (CD-ROM), a digital versatile disk read only memory (DVD-ROM), and a Universal Serial Bus (USB) memory. In addition, the various programs may be provided in a form of being downloaded from an external information processing apparatus or the like via a network.

In addition, the configuration, the operation, and the like of the information processing system 10 described in the above-described embodiment are merely examples, and it goes without saying that the configuration, the operation, and the like can be changed according to the situation within a range not departing from the gist of the present disclosure.

The following supplementary notes are further disclosed with respect to the above embodiment.

### Supplementary Note 1

A tree structure generation method executed by a computer, the method comprising:
calculating first hash values corresponding to each of a plurality of pieces of data classified into a plurality of data groups for each reference condition and arranged such that data having a common reference condition are adjacent to each other;
classifying a predetermined number of the first hash values as a group into a first hash value group;
calculating second hash values corresponding to each of the first hash value groups based on the first hash values belonging to a plurality of the first hash value groups; and
calculating a top hash value based on a plurality of the second hash values.

### Supplementary Note 2

The tree structure generation method according to Supplementary Note 1,
wherein the computer further performs
classifying a plurality of pieces of data for each of the reference condition before calculating the top hash value, and
changing an arrangement of the plurality of pieces of data for each of the reference condition.

### Supplementary Note 3

The tree structure generation method according to Supplementary Note 1 or 2,
wherein the computer further performs
classifying a predetermined number of the second hash values as a group into a second hash value group,
calculating intermediate hash values corresponding to each of the second hash value groups based on the second hash values belonging to a plurality of the second hash value groups, and
calculating a top hash value based on the intermediate hash values.

### Supplementary Note 4

The tree structure generation method according to any one of Supplementary Notes 1 to 3,
wherein the reference condition is at least one of a user ID, a registration date and time, or a format of data.

### Supplementary Note 5

The tree structure generation method according to Supplementary Note 3,
wherein the computer further performs classifying a plurality of the second hash values into a plurality of the second hash value groups such that the number of the second hash values included in the second hash value groups is two or one.

### Supplementary Note 6

The tree structure generation method according to any one of Supplementary Notes 1 to 5,
wherein the computer further performs registering the top hash value, the first hash values, or the first hash values and the second hash values in a blockchain.

### Supplementary Note 7

An information processing apparatus comprising a processor,
wherein the processor is configured to:
calculate first hash values corresponding to each of a plurality of pieces of data classified into a plurality of data groups for each reference condition and arranged such that data having a common reference condition are adjacent to each other;
classify a predetermined number of the first hash values as a group into a first hash value group;
calculate second hash values corresponding to each of the first hash value groups based on the first hash values belonging to a plurality of the first hash value groups; and
calculate a top hash value based on a plurality of the second hash values.

### Supplementary Note 8

An information processing system comprising:
the information processing apparatus according to Supplementary Note 7; and
a client computer that transmits the plurality of pieces of data to the information processing apparatus.

### Supplementary Note 9

A tree structure generation program for causing a computer to execute a process comprising:
calculating first hash values corresponding to each of a plurality of pieces of data classified into a plurality of data groups for each reference condition and arranged such that data having a common reference condition are adjacent to each other;
classifying a predetermined number of the first hash values as a group into a first hash value group;
calculating second hash values corresponding to each of the first hash value groups based on the first hash values belonging to a plurality of the first hash value groups; and
calculating a top hash value based on a plurality of the second hash values.

It should be noted that the disclosure of JP2023-203359 is incorporated in the present specification by reference. In addition, all documents, patent applications, and technical standards described in the present specification are incorporated in the present specification by reference to the same extent as in a case where individual documents, patent applications, and technical standards are specifically and individually indicated to be incorporated by reference.

What is claimed is:

1. A tree structure generation method executed by a computer, the method comprising:
calculating first hash values corresponding to each of a plurality of pieces of data classified into a plurality of data groups for each user ID and arranged such that data having a common user ID are adjacent to each other;
classifying a predetermined number of the first hash values as a group into a first hash value group;
calculating second hash values corresponding to each of the first hash value groups based on the first hash values belonging to a plurality of the first hash value groups; and
calculating a top hash value based on a plurality of the second hash values.

2. The tree structure generation method according to claim 1,
wherein the computer further performs
classifying a plurality of pieces of data for each of the user ID before calculating the top hash value, and changing an arrangement of the plurality of pieces of data for each of the user ID.

3. The tree structure generation method according to claim 1,
wherein the computer further performs
classifying a predetermined number of the second hash values as a group into a second hash value group,
calculating intermediate hash values corresponding to each of the second hash value groups based on the second hash values belonging to a plurality of the second hash value groups, and
calculating a top hash value based on the intermediate hash values.

4. The tree structure generation method according to claim 2,
wherein the computer further performs classifying a plurality of the second hash values into a plurality of the second hash value groups such that the number of the second hash values included in the second hash value groups is two or one.

5. The tree structure generation method according to claim 1,
wherein the computer further performs registering the top hash value, the first hash values, or the first hash values and the second hash values in a blockchain.

6. An information processing apparatus comprising a processor,
the processor being configured to:
calculate first hash values corresponding to each of a plurality of pieces of data classified into a plurality of data groups for each user ID and arranged such that data having a common user ID are adjacent to each other;
classify a predetermined number of the first hash values as a group into a first hash value group;
calculate second hash values corresponding to each of the first hash value groups based on the first hash values belonging to a plurality of the first hash value groups; and
calculate a top hash value based on a plurality of the second hash values.

7. An information processing system comprising:
the information processing apparatus according to claim 6; and
a client computer that transmits the plurality of pieces of data to the information processing apparatus.

8. A non-transitory computer-readable storage medium storing a tree structure generation program for causing a computer to execute a process comprising:
calculating first hash values corresponding to each of a plurality of pieces of data classified into a plurality of data groups for each user ID and arranged such that data having a common user ID are adjacent to each other;
classifying a predetermined number of the first hash values as a group into a first hash value group;
calculating second hash values corresponding to each of the first hash value groups based on the first hash values belonging to a plurality of the first hash value groups; and
calculating a top hash value based on a plurality of the second hash values.
